(19) United States
(12) Patent Application Publication
(10) Pub. No.: US 2017/0110722 A1
(43) Pub. Date: Apr. 20, 2017

(54) ANODE ACTIVE MATERIAL FOR SECONDARY BATTERY AND PREPARATION METHOD THEREOF

(71) Applicant: GS Energy Corp., Seoul (KR)

(72) Inventors: UngJu LEE, Seoul (KR); Dongjoon AHN, Seoul (KR); JongSoo KIM, Seoul (KR)

(73) Assignee: GS Energy Corp., Seoul (KR)

(21) Appl. No.: 15/058,230

(22) Filed: Mar. 2, 2016

(30) Foreign Application Priority Data
Oct. 15, 2015 (KR) 10-2015-0143951

(51) Int. Cl. H01M 4/38; H01M 4/587; H01M 4/04; H01M 10/0569; H01M 4/1395; H01M 4/66; H01M 10/0525; H01M 10/0568; H01M 4/36; H01M 4/134

(52) U.S. Cl. CPC H01M 4/386; H01M 4/366; H01M 4/364; H01M 4/587; H01M 4/0428; H01M 4/134; H01M 4/1395; H01M 4/0404; H01M 4/661; H01M 4/382; H01M 10/0525; H01M 10/0568; H01M 10/0569; H01M 2004/027

(57) ABSTRACT

The present disclosure provides an anode active material for a secondary battery, including: a composite particle including silicon and a first carbon; and carbon nanotube (CNTs) directly grown on a surface of the composite particle, in which the composite particle is a metal catalyst-free type for synthesizing carbon nanotubes, and a preparation method thereof. The present disclosure may provide a novel metal composite-based anode active material having excellent cycle life characteristics and high capacity of a battery.

### CROSS-REFERENCE TO RELATED APPLICATIONS

This application claims benefit and priority to Korean Patent Application No. 10-2015-0143951, filed on Oct. 15, 2015, with the Korean Intellectual Property Office, the disclosure of which is incorporated herein in its entirety by reference.

### TECHNICAL FIELD

The present disclosure relates to a novel metal composite-based anode active material having excellent cycle life characteristics and high capacity of a battery, and a preparation method thereof.

### BACKGROUND

Lithium secondary batteries have been widely used as a mobile power supply for a small device such as a mobile communication device, a laptop computer, and a camera. Recently, as the application field of the energy storage device has expanded to fields such as automobiles, new renewable energy, and smart grid, the application field of the lithium secondary battery is also expanding.

In order to exhibit excellent cycle life characteristics of the lithium secondary battery, a method of coating an anode material with amorphous carbon, a method of increasing the conductivity of an anode material, and the like are known. Further, in order to have high capacity, a method of using a metal oxide as an anode material or a method of using silicon oxide, and the like are known.

Meanwhile, silicon (Si) has low reaction potential with Li, and has a very high theoretical capacity of 4,200 mAh/g and excellent price competitiveness compared to a carbonaceous anode material, and thus is muchin the spotlight as a next-generation lithium secondary battery anode material. However, since there occurs a phenomenon in which the volume expands or shrinks by 4 times or more due to lithium ions as the charge and discharge cycle proceeds, there occurs a problem in that the cycle life characteristics and stability of a battery deteriorate due to the phenomenon.

In order to overcome the above-described problems of the silicon electrode material, studies on constituting an electrode material by compositing or differentiating silicon and a carbonaceous material, and the like have been conducted. However, these methods also still have a problem in that the capacity and cycle characteristics of the battery are decreased due to difficulty in controlling a change in structure caused by a change in volume of an anode active material in the continuous charge and discharge cycle, the structural instability of an anode such as peeling of an active material, and the like.

### SUMMARY

The present disclosure has been made in an effort to solve the above-described problems.

More specifically, an exemplary embodiment of the present disclosure provides a novel metal composite-based anode active material which may exhibit high capacity of a battery due to a silicon-based anode material by directly synthesizing carbon nanotubes (CNTs) on composite particles in which silicon and a carbonaceous material are composited, and may facilitate suppression of the volumetric expansion of an anode active material and physical and electrical contact between the particles, and thus may improve the cycle life characteristics even though the charge and discharge cycle is continued due to fibrous carbon nanotubes (CNTs) vapor-phase grown on the composite particles, and a lithium secondary battery comprising the same.

Another exemplary embodiment of the present disclosure provides a novel method of preparing an anode active material, which may achieve the economic efficiency caused by simplicity of the preparation process and cost reduction without separately using a metal catalyst which is essentially used when carbon nanotubes are synthesized in the related art.

Yet another exemplary embodiment of the present disclosure provides an anode active material for a secondary battery, comprising: a composite particle comprising silicon and a first carbon; and carbon nanotubes (CNTs) directly grown on a surface of the composite particle, in which the composite particle is a metal catalyst-free type for synthesizing carbon nanotubes.

According to a preferred exemplary embodiment of the present disclosure, the composite particle may include an amorphous second carbon coating layer formed on a part or entire of the surface of the composite particle.

Still another exemplary embodiment of the present disclosure provides a method of preparing an anode active material comprising: (i) preparing a composite particle including silicon and a first carbon, in which the first carbon contains 150 ppm to 5,000 ppm of metal impurities; (ii) activating the composite particle by maintaining the composite particle at 400° C. to 900° C. for more than 30 minutes and less than 90 minutes; and (iii) vapor-phase growing carbon nanotubes on a surface of the activated composite particle by performing a heat treatment at a temperature which is equal to or more than a decomposition temperature of a hydrocarbon gas while supplying a hydrocarbon gas under metal catalyst-free conditions.

Still yet another exemplary embodiment of the present disclosure provides an anode for a secondary battery, comprising the above-described anode active material, and a lithium secondary battery including the same.

According to the exemplary embodiments of the present disclosure, the metal composite-based anode material facilitates contact between anode material particles when electrodes are formed, and thus decreases contact resistance which is advantageous in movement of electrons, thereby leading to excellent cycle life characteristics of a battery because fibrous carbon nanotubes are formed on the surface of the composite particle.

High capacity characteristics of a battery according to the use of silicon may be exhibited by using a composite particle of silicon and a carbonaceous material, and the performance of an anode material for a lithium secondary battery may be improved by efficiently alleviating the volumetric expansion of silicon incurred during the charge and discharge of the battery.

Since a metal catalyst used during the synthesis of carbon nanotubes is not separately used, economic efficiency and process simplicity may be provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an SEM photograph of an anode active material particle prepared in Comparative Example 2.

FIG. 2 is an SEM photograph of an anode active material particle prepared in Example 1.

FIG. 3 is a TEM photograph illustrating carbon nanotubes formed on the surface of the anode active material in Example 1.

FIG. 4 is a TEM photograph in which carbon nanotubes in FIG. 3 are enlarged.

FIG. 5 is a graph illustrating cycle life characteristics of lithium secondary batteries comprising the anode active materials in Comparative Examples 1 to 4 and Example 1.

FIG. 6 is a graph illustrating cycle life characteristics of lithium secondary batteries comprising the anode active materials in Examples 1 to 3.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

The present disclosure provides a novel metal composite-based anode active material in which carbon nanotubes (CNTs) are directly vapor-phase grown on a composite particle in which silicon and a first carbon are composited without separately using a metal catalyst for synthesizing CNTs in the related art.

The anode active material may effectively control a large change in volume of an electrode active material incurred during the charge and discharge of a battery, which causes the largest problem in the commercialization of silicon electrode active materials in the related art, and may also improve low electrical conductivity of silicon.

CNTs formed on the surface of the anode active material have an effect of suppressing propylene carbonate(PC)-based electrolyte solution from being decomposed and have high electrical conductivity, and thus may stably maintain cycle life characteristics of the battery.

Since a metal catalyst for synthesizing CNTs in the related art is not separately used in the present disclosure, a process of supporting the existing metal catalyst itself does not need to be performed, and it is possible to achieve economic efficiency and mass productivity caused by simplicity of the preparation process and cost reduction.

Hereinafter, a novel metal composite-based anode active material according to the present disclosure and a preparation method thereof will be described in detail.

<Metal Composite-Based Anode Active Material>

The metal composite-based anode active material according to the present disclosure includes: (a) a composite particle including silicon and a first carbon; and (b) carbon nanotubes (CNTs) directly grown on a surface of the composite particle.

In the related art, a process of separately supporting a metal catalyst on a support and growing CNTs at a position in which the metal catalyst is positioned is usually performed. When CNTs are synthesized by separately using a metal catalyst as described above, it is highly likely that the metal catalyst is included in a final product without being evaporated even when CNTs are synthesized or in the subsequent high temperature heat-treatment process because the content of the metal catalyst is generally in the level of several weight % based on the total weight of the support. When the final product in which the metal catalyst is remaining is used as an anode material for a secondary battery as described above, lithium dendrite may be deposited on the surface of the anode during the charging process, and as the charge and discharge is repeated, lithium dendrite is grown, and thus, peeling and the like occur, thereby leading to deterioration in cycle life characteristics of the battery. Further, the metal catalyst itself is directly peeled off from the surface of the anode material, or grown lithium dendrite is peeled off, passes through a separator, and causes a short-circuit of the battery, thereby incurring a safety problem in that the battery may be ignited.

In contrast, the composite particle of the present disclosure is a metal catalyst-free type in which a metal catalyst for synthesizing carbon nanotubes is not separately used before the CNTs are synthesized, and does not include the metal even after the CNTs are finally synthesized.

More specifically, the carbon nanotubes (CNTs) may be formed on a part or all of the surface of a composite particle including silicon and a first carbon. In this case, it is preferred that the carbon nanotubes have a structure in which the end portion at one side thereof is physically and/or chemically bonded to the surface of an anode active material.

In the present disclosure, the length and thickness of the carbon nanotubes are not particularly limited, and for example, the thickness of fibrous carbon nanotubes may be in the range of 10 nm to 200 nm, preferably 20 nm to 100 nm. Further, the length of carbon nanotubes is not also particularly limited as long as anode active material particles are easily brought into contact with each other, and for example, the length may be in the range of 100 nm to 10 μm, preferably 200 nm to 1 μm.

The shape of the carbon nanotubes is not particularly limited, and the carbon nanotubes may be single-walled (SW) carbon nanotubes, double-walled (DW) carbon nanotubes, multi-walled (MW) carbon nanotubes, or in the form in which the carbon nanotubes are mixed.

The carbon nanotubes (CNTs) according to the present disclosure exhibit a specific Raman peak intensity ratio (I₁₃₅₀/I₁₅₈₀) by the Raman spectrum measurement, exhibiting the degree of crystallization of CNTs.

That is, a peak of the crystalline portion and a peak of the amorphous portion are present in a Raman analysis graph of the CNTs. The I₁₅₈₀ means an intensity of a peak (1580 cm⁻¹) of the crystalline portion, and the peak is a peak generated by stretching two adjacent carbon atoms in opposite directions in a graphite plate. The I₁₃₅₀ means an intensity of a peak (1350 cm⁻¹) of the amorphous portion, and the peak is a peak shown by deformation or defects and the like of the lattices in an amorphous carbon or graphite plate. Therefore, the crystallinity of CNT may be defined by comparing the I₁₃₅₀ with the I₁₅₈₀. In this case, a large value of the Raman peak intensity ratio (I₁₃₅₀/I₁₅₈₀) means that the degree of crystallization of CNTs is low.

Accordingly, the carbon nanotubes of the present disclosure may have a ratio of a peak intensity I₁₃₅₀ at 1350 cm⁻¹ to a peak intensity I₁₅₈₀ at 1580 cm⁻¹, an I₁₃₅₀/I₁₅₈₀ value, in a range of 0.7 to 1.1, preferably 0.8 to 1.0 in the Raman spectrum. When the Raman peak intensity ratio (I₁₁₃₅₀/I₁₅₈₀) of the CNTs satisfies the above-described range, an anode active material including the CNTs may effectively control the volumetric expansion rate of the anode active material caused by the charge and discharge of the battery, and a lithium secondary battery including the anode active material may implement long cycle life characteristics.

The content of the carbon nanotubes may be in a range of 0.1 to 5 wt %, preferably 0.1 to 3 wt %, based on the total weight of the anode active material.

A target material in which the above-described CNTs are synthesized is a composite particle including silicon and a first carbon.

The composite particle is not particularly limited as long as the composite particle is in the form of including silicon and a carbonaceous material, and for example, may be in the form in which silicon and a first carbon are mixed or dispersed by a typical dry method or wet method, and the like known in the art, or in the form in which silicon and the first carbon are chemically bonded to each other. Preferably, the composite particle may be in the form in which silicon fine particles are uniformly distributed in a spheroidized first carbon particle.

The first carbon in the composite particle may be a typical carbonaceous material known in the art, and for example, may be one or more selected from the group consisting of low-crystalline soft carbon, amorphous hard carbon, natural graphite, and artificial graphite. Preferably, the first carbon in the composite particle may be crystalline natural graphite, artificial graphite, or a combination thereof, more preferably crystalline natural graphite. In this case, the graphite may be amorphous, plate, flake, and spherical, and is preferably a spheroidized spherical particle.

The first carbon may have an average particle diameter in a range of 1 μm to 30 μm, preferably 10 μm to 20 μm.

As the silicon, a typical silicon-based material known in the art may be used without limitation, and for example, the silicon may be Si, SiOx (0<x<2), a Si—C composite, an Si-Q alloy, or a combination thereof, and the like. The Q is an alkali metal, an alkaline earth metal, an element of Groups 13 to 16, a transition metal, a rare earth element, or a combination thereof, and Si is excluded from Q. Specific examples of Q include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. Q may be preferably a silicon fine particle.

The composite particle according to the present disclosure exhibits a specific Raman peak intensity ratio (I₅₂₀/I₁₅₈₀) by the Raman spectrum measurement, exhibiting that silicon is included in the composite particle. Therefore, it can be seen through the intensity ratio of the Raman peak that the composite particle is Si—C composited.

The Raman spectrum was measured by using a LabRam Aramis device manufactured by Horiba Jobin Yvon, Inc., to use a wavelength of 514 nm of Ar-ion laser and setting the exposure time for each sample to 30 seconds, and an average value obtained by randomly measuring five spots per sample was used.

Here, I₅₂₀ means an intensity of a peak (520 cm⁻¹) derived from Si, and the I₁₅₈₀ means an intensity of a peak (1580 cm⁻¹) derived from carbon. The I₅₂₀/I₁₅₈₀ may be compared to determine whether Si is contained in the composite particle and define the content thereof, and the like, and in this case, a large value of the Raman peak intensity ratio (I₅₂₀/I₁₅₈₀) means that the content of silicon in the composite particle is high.

Accordingly, the composite particle of the present disclosure may have a ratio of a peak intensity I₅₂₀ derived from Si at 520 cm⁻¹ to a peak intensity I₁₅₈₀ derived from carbon at 1580 cm⁻¹, an I₅₂₀/I₁₅₈₀ value, in a range of 1.0 to 2.0, preferably 1.2 to 1.8 in the Raman spectrum. When the Raman peak intensity ratio (I₅₂₀/I₁₅₈₀) of the composite particle satisfies the above-described range, an anode active material including the composite particle may effectively control the volumetric expansion rate of the anode active material caused by the charge and discharge, and a lithium secondary battery including the anode active material may implement long cycle life characteristics.

When the crystallite size of silicon included in the composite particle is measured by an X-ray diffraction method using CuKa rays, the (111) diffraction peak in the Si phase may have a full width at half maximum in a range of 0.2° to 1.0°.

The silicon may have an average particle diameter of 0.01 μm to 5 μm, specifically, 0.1 μm to 0.2 μm. When the average particle diameter of the silicon-based material satisfies the range, the volumetric expansion rate may be decreased while high capacity is implemented.

In general, as the content of silicon is increased, high capacity may be implemented, whereas the volumetric expansion rate is increased. In the composite particle according to the present disclosure, the content ratio of silicon to the first carbon may be in a range of 1 to 20:80 to 99 parts by weight, preferably 3 to 10:90 to 97 parts by weight. When the composite particle satisfies the above-described content range, an excellent battery performance may be implemented.

The composite particle according to the present disclosure may comprise an amorphous second carbon coating layer formed on a part or all of the surface of the particle. The second carbon coating layer is not particularly limited, and may be, for example, soft carbon, hard carbon, a mesophase pitch carbide, a sintered coke, amorphous carbon produced from a carbonized gas, or a mixed form thereof, and the like. Since the second carbon coating layer serves to keep the form of an anode active material more firmly, it is possible to control a change in volume of the silicon anode material during the charge and discharge. Furthermore, conductivity may be imparted.

The average particle diameter of the composite particle may be in a typical range in which the composite particle may be used as an anode active material, and may be, for example, in a range of 5 μm to 30 μm, preferably 5 μm to 20 μm.

<Method of Preparing Metal Composite-Based Anode Active Material>

Hereinafter, a method of preparing a metal composite-based anode active material will be described according to the present disclosure. However, the method is not limited to the following preparation method, and if necessary, the step of each process may be modified or optionally mixed and performed.

According to a preferred exemplary embodiment, the preparation method may comprise: (i) preparing a composite particle including silicon and a first carbon, in which the first carbon contains 150 ppm to 5000 ppm of metal impurities (step S10); (ii) activating the composite particle by maintaining the composite particle at 400° C. to 900° C. for more than 30 minutes and less than 90 minutes (step S20); and (iii) vapor-phase growing carbon nanotubes on a surface of the activated composite particle by performing a heat treatment at a temperature which is equal to or more than a decomposition temperature of a hydrocarbon gas while supplying a hydrocarbon gas under metal catalyst-free conditions (step S30).

The method of preparing silicon/carbon composite particle in which carbon nanotubes (CNTs) are formed on the surface according to the present disclosure will be described below in more detail by dividing the method into each step.

(1) Preparing Composite Particle Including Silicon and First Carbon (hereinafter, referred to as ‘step S10’)

Step S10 is a step of preparing a composite particle containing silicon and a first carbon as a target material in which carbon nanotubes are to be synthesized.

When carbon nanotubes are vapor-phase grown in the related art, a metal preparation catalyst, which may synthesize CNTs on the target material, not only needs to be inevitably used, but also the amount of catalyst used needs to be relatively large.

In contrast, the present disclosure uses a carbon particle containing a trace of metal impurities (however, except for carbon) in the particle as a first carbonaceous material forming a composite particle. Accordingly, since in the present disclosure, a process of separately dispersing and supporting a metal catalyst itself used when the CNTs are prepared in the related art does not need to be performed and the metal catalyst is not even used, the easiness of the preparation process and a cost reducing effect may be exhibited.

In the present disclosure, the first carbonaceous material particle forming the composite particle is a typical carbonaceous material known in the art, and includes a specific content of metal impurities therein.

Non-limiting examples of the first carbonaceous material particle which may be used include low-crystalline soft carbon, amorphous hard carbon, natural graphite, artificial graphite, or a mixed form thereof, and the like. Preferably, the first carbonaceous material particle may be crystalline natural graphite, artificial graphite, or a combination thereof, more preferably crystalline natural graphite. In this case, the graphite may be an undefined crystal structure, plate, flake, and spherical, and is preferably a spheroidized spherical particle.

The metal impurity is a metal component derived from impurities inevitably included in the first carbonaceous material particle, and may be a typical metal or metal oxide, which may synthesize CNTs. The metal impurity may be, for example, Fe, Cu, Pb, Co, Ni, Pt, Pd, Mn, Mo, Cr, Sn, Au, Mg, Al, Ca, K, Na, P, Zn, Nb, a metal including one or more thereof, or a metal oxide including one or more thereof. Alternatively, the metal impurity may also include oxides such as SiO₂ and ZrO₂.

The content of the metal impurity is not particularly limited as long as the content is in a range in which CNTs may be subsequently synthesized by supplying a hydrocarbon gas, and may be, for example, in a range of 150 ppm to 5,000 ppm based on the total weight of the first carbonaceous material, and preferably, the content of metal impurities including Fe and Ni may be in a range of 150 ppm to 3,000 ppm. In this case, the content of metal impurities may be in a range of 0.01 wt % to 5 wt %, preferably 0.015 wt % to 3 wt %, based on the total weight of the first carbonaceous material.

The composite particle may be obtained by compositing silicon-containing fine particles with a first carbonaceous material particle including the above-described metal impurities by a typical method known in the art, for example, a dry method and/or a wet method. For example, the composite particle may be composited by mechanically alloying silicon fine particles with a spheroidized first carbon particle by a milling method or a pulverization crushing method, a mechano-fusion method, and the like.

As a preferred exemplary embodiment of step S10, silicon-containing fine particles may be composited on the surface of the first carbonaceous material particle by mixing a first carbonaceous material particle with silicon-containing fine particles in an alcohol dispersion medium by using a wet method, and then removing the dispersion medium by vacuum drying. Here, an additional oxidation may be prevented in a process of compositing silicon-containing fine particles by using alcohol as a dispersion medium, and simultaneously performing vacuum drying.

As the alcohol, typical alcohol known in the art may be used without limitation, and the amount of alcohol used is also particularly limited.

In the present disclosure, the preparation method may further include a step (i−1) of coating the surface of a composite particle in which the first carbonaceous material particle and silicon are composited with a carbonizable precursor, and then performing a heat treatment at a temperature which is equal to or more than the temperature at which the precursor is carbonized.

The carbonizable precursor is not particularly limited as long as the precursor is a material which may be carbonized by firing, and non-limiting examples thereof include a petroleum-based pitch, a coal-based pitch, a mesophase pitch, a coal-tar pitch, a heat treatment pitch, a vinyl chloride-based resin, a vinyl-based polymer, an aromatic hydrocarbon, a nitrogen ring compound, a sulfur ring compound, a coal-based heavy oil such as a coal liquefied oil, a straight run-based heavy oil such as asphaltene, a petroleum-based heavy oil such as a decomposition-based heavy oil such as naphtha tar produced as a by-product when crude oil, naphtha, and the like are thermally decomposed, a decomposition-based heavy oil, and the like. In this case, these carbonizable precursors may be used alone or used in mixture of two or more thereof.

The content of the carbonizable material is not particularly limited as long as the composite particle may be bound, and may be, for example, in a range of 5.0 parts by weight to 50 parts by weight, preferably 5.0 parts by weight to 30 parts by weight, based on 100 parts by weight of the composite particle. When the content of the carbonizable material corresponds to the above-described range, an effect of binding a desired carbon particle may be sufficiently exhibited, and it is possible to minimize deterioration in properties of the anode active material caused by adding a carbon precursor.

As the coating method, a typical mixing method publicly known in the art may be used without limitation, and general mixing may be performed or a dry or wet mechanical milling method may be used for achieving uniform mixing. The coating may be performed by a dry process, a wet process, or a mixed process in which the dry process and the wet process are combined. In this case, the coating time and conditions may be appropriately adjusted by the component and content of the composite particle and the component and content of the carbonizable material.

Thereafter, the composite particle coated with the precursor is subjected to heat treatment, and through the heat treatment, carbonization of the carbonizable material, removal of impurities, and surface properties may be improved.

In this case, the heat treatment temperature is not particularly limited as long as the heat treatment temperature is a temperature which is equal to or more than a temperature at which the carbonizable material is carbonized. For example, the heat treatment may be performed at 800° C. or more, and sintering may be performed preferably in a range of 800° C. to 1,300° C. for 20 minutes to 72 hours. In this case, when the heat treatment temperature corresponds to the above-described range, carbonization of the carbonizable material may sufficiently proceed, and impurities in the carbon particle may be perfectly removed.

(2) Activating Composite Particle (hereinafter, referred to as ‘step S20’)

In the present step S20, the metal impurities included in the composite particle are surface-activated by performing heat treatment on the composite particle prepared in the previous step S10 for a predetermined time. The activated metal impurities as described above serve as a preparation catalyst for synthesizing CNTs in the subsequent step S30.

As a preferred exemplary embodiment of step S20, the composite particle is maintained at 400° C. to 900° C. for more than 30 minutes and less than 90 minutes. In this case, when the temperature and the time exceed the activation temperature and the activation maintenance time, respectively, the metal impurities fail to serve as a catalyst for synthesizing CNTs, so that CNTs are not synthesized on the surface of the composite particle.

Meanwhile, when the activation temperature of S20 step is increased, the activation maintenance time tends to be lowered, so that the activation maintenance time may be appropriately and variously adjusted depending on the type and amount of metal impurity included in the composite particle.

(3) Phase Vapor Growing Carbon Nanotubes (hereinafter, referred to as ‘step S30’)

In S30 step, carbon nanotubes are vapor-phase grown on the surface of the activated composite particle by performing heat treatment at a temperature which is equal to or more than the decomposition temperature of a hydrocarbon gas under a separate metal catalyst-free condition while supplying the hydrocarbon gas which is a carbon supply source.

As the hydrocarbon gas which may be used in the present disclosure, a typical carbon supply source known in the art may be used, and the hydrocarbon gas may be, for example, one or more selected from the group consisting of carbon monoxide, methane (including LNG), propane (including LPG), butane, acetylene, and ethylene. Preferably, the hydrocarbon gas may be a hydrocarbon gas represented by CₓH_{y} (x: 1 to 3, y: 2 to 11), more preferably, acetylene (C₂H₂).

The heat treatment temperature is not particularly limited as long as the temperature is equal to or more than the temperature in which the hydrocarbon gas is thermally decomposed. The temperature may be, for example, in a range of 500° C. to 1,300° C., preferably 700° C. to 1,000° C. In addition, the heat treatment time is not particularly limited, and may be, for example, 1 minute to 60 minutes, preferably 3 minutes to 30 minutes.

As a preferred exemplary embodiment of step S30, CNTs are synthesized by performing a chemical vapor phase deposition method under a mixed gas atmosphere in which a hydrocarbon gas and an inert gas are mixed at 500° C. to 1,300° C. for 1 minute to 60 minutes.

In this case, the composition of the mixed gas is not particularly limited, and may be, for example, any one of nitrogen-acetylene, hydrogen-acetylene, nitrogen-acetylene-hydrogen, argon-acetylene, argon-acetylene-hydrogen, argon-propylene, hydrogen-propylene, argon-propylene-hydrogen, argon-butylene, hydrogen-butylene, argon-butylene-hydrogen, nitrogen-propylene, nitrogen-propylene-hydrogen, nitrogen-butylene, and nitrogen-butylene-hydrogen. In this case, it is preferred that the ratio of the hydrocarbon gas is 5 wt % to 90 wt % based on the total weight of the mixed gas. When the hydrocarbon gas is adjusted in the above-described weight ratio range, it is possible to easily adjust the thickness and content of the carbon nanotubes formed on the surface of the composite particle of silicon and a first carbonaceous material.

The content of the carbon nanotubes synthesized as described above is in a range of 0.1 wt % to 5 wt % based on the total weight of the metal composite-based anode active material of the present disclosure, and may be preferably in a range of 0.15 wt % to 3 wt %.

Carbon nanotubes may be directly vapor-phase grown on the surface of the composite particle by thermally decomposing and carbonizing a hydrocarbon gas on the surface of the composite particle of silicon-first carbon as described above. Through this, electrical conductivity and mechanical stability of silicon particles are increased, and the volumetric expansion ratio of silicon particles may be significantly decreased in the continuous charge and discharge process.

<Anode Material and Lithium Secondary Battery>

The present disclosure provides an anode material for a secondary battery, including a silicon/carbon composite particle in which the above-described carbon nanotubes (CNTs) are formed on the surface of the particle as an anode active material, and a lithium secondary battery including the anode material.

More specifically, the anode comprises a plurality of anode active material particles, and may have a structure in which the anode active material particles are physically or electrically connected with each other by carbon nanotubes (CNTs) formed on the surface of the anode active material particle. Accordingly, the anode active materials are easily brought into contact with each other while effectively controlling the volumetric expansion of a silicon anode, thereby lowering the contact resistance which is advantageous in movement of electrons and improving cycle life characteristics of a battery.

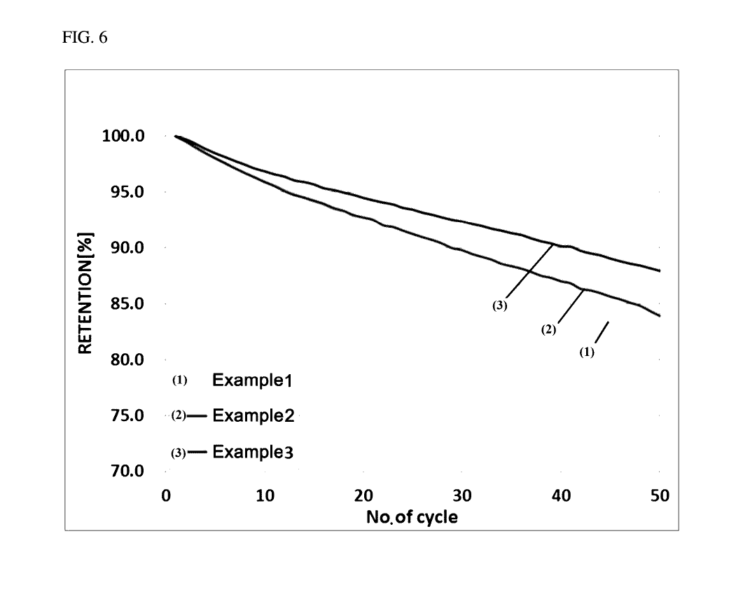

Actually, it can be seen that when a silicon/carbon composite particle in which carbon nanotubes (CNTs) of the present disclosure are formed on the surface is used as an anode active material, cycle life characteristics are improved by 3% to 10% or more after 50 charge and discharge cycles (see the following Tables 2 and 3 and FIGS. 5 and 6).

Here, the anode material of the present disclosure is required to at least include a silicon/carbon composite particle in which the above-described carbon nanotubes (CNTs) are formed on the surface as an anode active material. For example, the silicon/carbon composite particle in which carbon nanotubes (CNTs) are formed on the surface itself is used as an anode active material, or an anode mixture in which a silicon/carbon composite particle in which carbon nanotubes (CNTs) are formed on the surface and a binding agent are mixed, an anode mixture paste obtained by additionally adding a solvent, an anode formed by additionally applying the anode mixture paste on a current collector, and the like fall within the scope of the anode material of the present disclosure.

The anode may be prepared by a typical method known in the art, and may be prepared, for example, by mixing and stirring a binder, if necessary, a conducting agent, and a dispersing agent, with an electrode active material to prepare a slurry, applying (coating) the slurry on a current collector, compressing the current collector, and then drying the current collector.

In this case, as an electrode material such as a dispersion medium, a binder, a conducting agent, and a current collector,a typical electrode material known in the art may be used, and based on the amount of the electrode active material, the binder may be used in a range of 1 part by weight to 10 parts by weight, and the conducting agent may be appropriately used in a range of 1 part by weight to 30 parts by weight.

Non-limiting examples of the conducting agent which may be used include carbon black, acetylene black-series or Gulf Oil Company, Ketjen Black, Vulcan (Vulcan) XC-72, Super P, and the like.

Representative examples of the binding agent include polytetrafluoroethylene (PTFE), polyvinylidene fluoride (PVdF) or a copolymer thereof, styrene butadiene rubber (SBR), cellulose, polyacrylic acid, and the like, and representative examples of the dispersing agent include isopropyl alcohol, N-methylpyrrolidone (NMP), acetone, distilled water, and the like.

The current collector of the metal material is a highly conductive metal, and as a metal to which the paste of the material may be easily adhered, any metal having no reactivity in the voltage range of the battery may be used. Examples thereof include mesh such as aluminum, copper or stainless steel, foil, and the like.

The present disclosure provides a secondary battery including the electrode, preferably a lithium secondary battery.

The secondary battery of the present disclosure is not particularly limited except that the above-described silicon/carbon composite particle in which carbon nanotubes (CNTs) are formed on the surface is used, and may be prepared by a typical method known in the art. For example, the secondary battery of the present disclosure may be prepared by inserting a separator between a cathode (a positive electrode) and an anode (a negative electrode), and introducing a non-aqueous electrolyte.

In this case, the secondary battery of the present disclosure includes the anode, the cathode, the separator, and the electrolyte as battery constituent elements, and here, the constituent elements of the cathode, the separator, the electrolyte, and other additives if necessary except for the above-described anode correspond to the elements of a typical lithium secondary battery known in the art.

For example, as the cathode, a typical cathode active material for a lithium secondary battery known in the art may be used, and non-limiting examples thereof include a lithium transition metal composite oxide (for example, lithium manganese composite oxides such as LiMn₂O₄, lithium nickel oxides such as LiNiO₂, lithium cobalt oxides such as LiCoO₂, a moiety in which a portion of manganese, nickel and cobalt of these oxides is substituted with other typical transition metals, and the like, or vanadium oxides containing lithium, and the like) such as LiMₓO_{y} (M=Co, Ni, Mn, CoₐNi_{b}Mn_{c}), or chalcogenide compounds (for example, manganese dioxide, titanium disulfide, molybdenum disulfide, and the like), and the like.

The non-aqueous electrolyte includes electrolyte components typically known in the art, for example, an electrolyte salt and an electrolyte solvent.

The electrolyte salt may be composed of a combination of (i) a cationic ion selected from the group consisting of Li⁺, Na⁺, and K⁺ and (ii) an anionic ion selected from the group consisting of PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻, and among them, a double lithium salt is preferred. Specific examples of the lithium salt include LiClO₄, LiCF₃SO₃, LiPF₆, LiBF₄, LiAsF₆, LiN(CF₃SO₂)₂, and the like. These electrolyte salts may be used alone or in mixture of two or more thereof.

As the electrolyte solvent, a cyclic carbonate, a linear carbonate, lactone, ether, ester, acetonitrile, lactam, and ketone may be used.

Examples of the cyclic carbonate include ethylene carbonate (EC), propylene carbonate (PC), butylene carbonate (BC), fluoroethylene carbonate (FEC), and the like, and examples of the linear carbonate include diethyl carbonate (DEC), dimethyl carbonate (DMC), dipropyl carbonate (DPC), ethyl methyl carbonate (EMC), methyl propyl carbonate (MPC), and the like. Examples of the lactone include gamma butyrolactone (GBL), and examples of the ether include dibutyl ether, tetrahydrofuran, 2-methyl tetrahydrofuran, 1,4-dioxane, 1,2-dimethoxyethane, 1,2-diethoxyethane, and the like. Examples of the ester include methyl formate, ethyl formate, propyl formate, methyl acetate, ethyl acetate, propyl acetate, methyl propionate, ethyl propionate, butyl propionate, methyl pivalate, and the like. Further, the lactam includes N-methyl-2-pyrrolidone (NMP), and the like, and the ketone include polymethyl vinyl ketone. In addition, halogen derivatives of the organic solvent may be used, but the example is not limited thereto. Furthermore, as the organic solvent, glyme, diglyme, triglyme, and tetraglyme may also be used. These organic solvents may be used alone or in mixture of two or more thereof.

The separator may use a porous material which serves to block an internal short-circuit of both electrodes and impregnate the electrolytic solution without limitation. Non-limiting examples thereof include polypropylene-based, polyethylene-based, and polyolefin-based porous separators, or a composite porous separator in which an inorganic material is added to the porous separator, and the like.

Hereinafter, the present disclosure will be described in more detail with reference to the following Examples, but these Examples are provided only for describing the present disclosure in more detail, and it will be obvious to a person with ordinary skill in the art that the scope of the present disclosure is not limited by these Examples according to the gist of the present disclosure.

### EXAMPLE 1

### Preparation of Metal Composite-Based Anode Active Material

1-1. Preparation of Anode Active Material

A silicon metal was wet composited with a spherical graphite particle having a metal impurity content of 150 ppm or more, and then, the composite was activated by being maintained at 450° C. for 60 minutes. Thereafter, the composite was heated to 600° C., a reaction gas containing 5% of an acetylene (C₂H₂) gas was supplied to a nitrogen (N₂) gas, and then the mixture was reacted for 5 minutes to prepare a metal composite-based anode active material in which carbon nanotubes were grown on the surface.

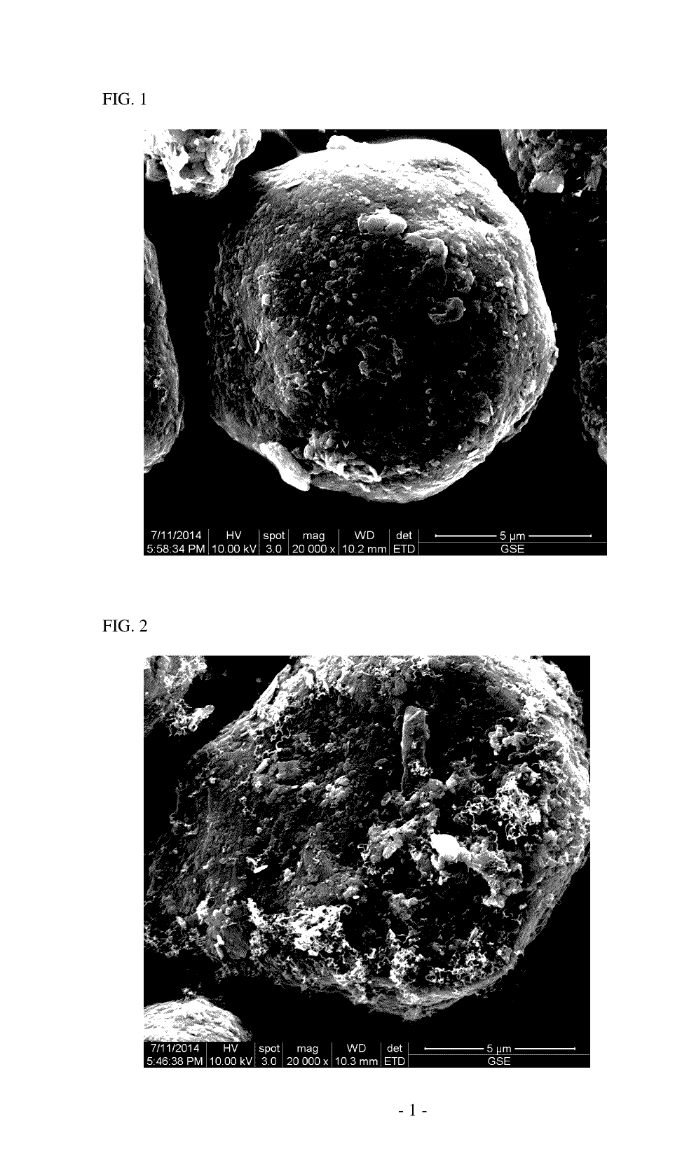

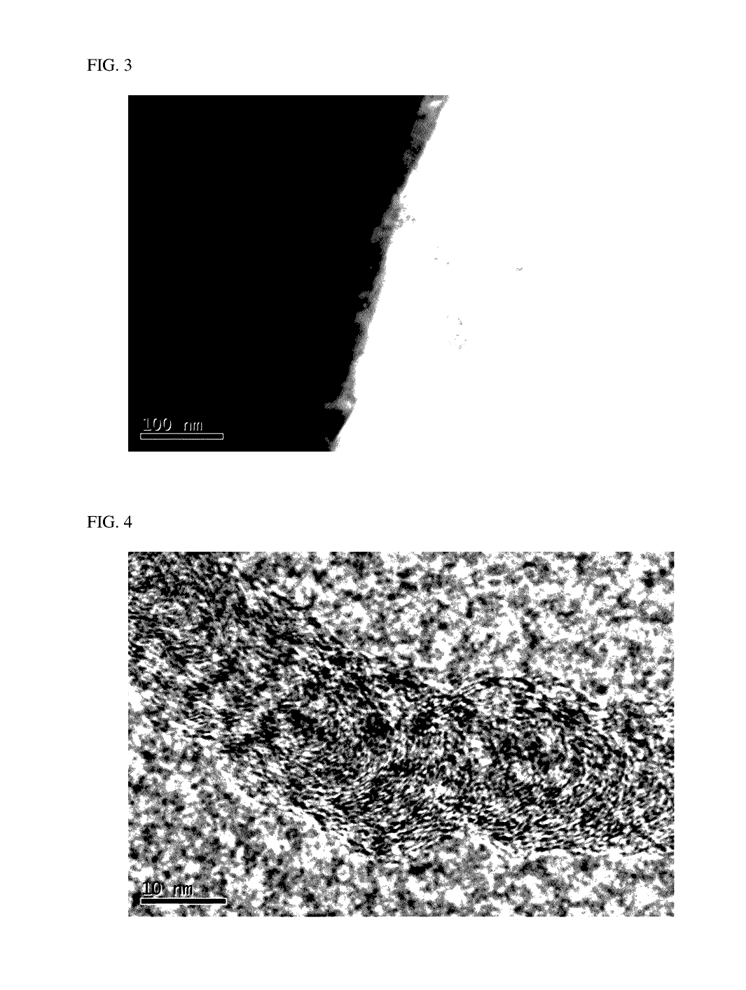

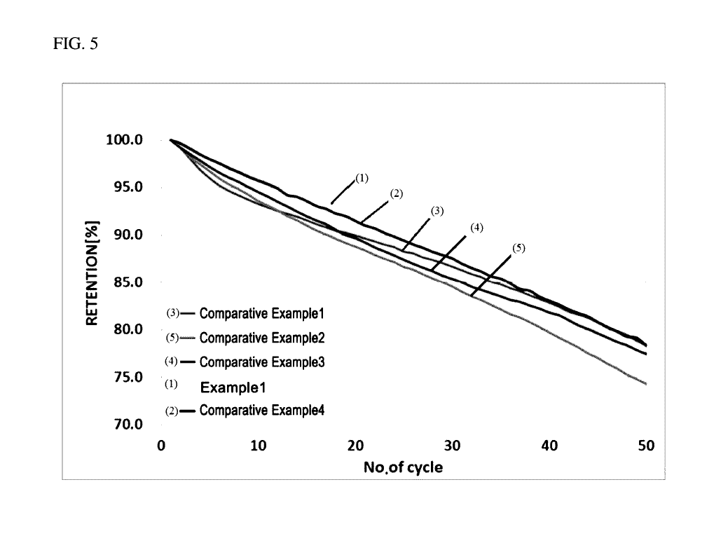

SEM and TEM photographs of the metal composite-based anode active material prepared as described above in Example 1 are shown in the following FIGS. 2 and 3, respectively. Furthermore, FIG. 4 is a TEM photograph illustrating carbon nanotubes (CNTs) having a thickness of 20 nm.

1-2. Preparation of Secondary Battery

90 weight % of the metal composite-based anode active material prepared in Example 1-1, 6 weight % of a binder, and 4 weight % of a conducting agent were mixed to obtain slurry through a slurry casting method. The slurry was applied on a copper foil, which is a current collector, and then dried and the copper foil was rolled to prepare an electrode. As a counter electrode of an electrode containing the metal composite-based anode active material, a lithium metal was used, 2016 coin cells were formed by using EC/DEC/FEC in which 1 M LiPF₆ was dissolved as an electrolyte, and the performance thereof was evaluated at room temperature.

The voltage in a range of 0.005 V to 1.5 V was applied, and the charge and discharge with a current in a range of 0.7 mA (0.2 C) was performed to measure a discharge capacity of 0.2 C as an initial capacity. Further, for the cycle life characteristics, the capacity maintenance ratio was measured at 50 cycles by performing a charge and discharge of 3.5 mA (1.0 C).

### EXAMPLE 2

A metal composite-based anode active material in which carbon nanotubes were grown in Example 2 and a secondary battery including the same were each prepared by performing the same method as in Example 1, except that the composite was maintained at 500° C. for 60 minutes instead of being maintained at 450° C. for 60 minutes.

### EXAMPLE 3

A metal composite-based anode active material in which carbon nanotubes were grown in Example 3 and a secondary battery including the same were each prepared by performing the same method as in Example 1, except that the composite was maintained at 550° C. for 60 minutes instead of being maintained at 450° C. for 60 minutes.

### COMPARATIVE EXAMPLE 1

A silicon metal was wet composited with a spherical graphite particle having a metal impurity content of less than 50 ppm, and then, the composite was activated by being maintained at 450° C. for 60 minutes. Thereafter, the composite was warmed to 600° C., a reaction gas containing 5% of acetylene (C₂H₂) gas was supplied to a nitrogen (N₂) gas, and then the mixture was reacted for 5 minutes to prepare an anode active material in Comparative Example 1 and a secondary battery including the same.

### COMPARATIVE EXAMPLE 2

An anode active material in Comparative Example 2 and a secondary battery including the same were prepared by performing the same method as in Comparative Example 1, except that a spherical graphite particle with a metal impurity content of 150 ppm or more was used instead of a spherical graphite particle with a metal impurity content of less than 50 ppm, and the activation maintenance time was changed to 0 minute.

### COMPARATIVE EXAMPLE 3

A metal composite-based anode active material in Example 3 and a secondary battery including the same were each prepared by performing the same method as in Example 1, except that the composite was maintained at 450° C. for 30 minutes instead of being maintained at 450° C. for 60 minutes.

An SEM photograph of the metal composite-based anode active material prepared as described above in Comparative Example 3 is shown in FIG. 1.

### COMPARATIVE EXAMPLE 4

A metal composite-based anode active material in which carbon nanotubes were grown in Example 4 and a secondary battery including the same were each prepared by performing the same method as in Example 1, except that the composite was maintained at 450° C. for 90 minutes instead of being maintained at 450° C. for 60 minutes.

### EXPERIMENTAL EXAMPLE 1

### Evaluation of Content of Impurities in Carbonaceous Material

The content of impurities in the spherical graphite particles used in each of Examples 1 to 3 and Comparative Examples 1 to 4 of the present disclosure was measured through an ICP-OES analysis, and the results are described in the following Table 1.

TABLE 1

| | Content of Metal Impurities (ppm) | | | | | | |
|---|---|---|---|---|---|---|---|
| | Fe | Ni | Zn | Cr | Na | Ca | Al |
| Comparative | 42.5 | 0.8 | 0.5 | 0.7 | 4.3 | — | — |
| Example 1 | | | | | | | |
| Examples 1 to 3 | 243.8 | 1.3 | 0.9 | 0.8 | 4.5 | 77.0 | 320 |
| Comparative | 243.8 | 1.3 | 0.9 | 0.8 | 4.5 | 77.0 | 320 |
| Examples 2 to 4 | | | | | | | |

### EXPERIMENTAL EXAMPLE 2

### Evaluation of Growth of CNTs Depending on Activation Maintenance Time and Characteristics of Battery

In order to confirm a change in growth of carbon nanotubes (CNTs) depending on the maintenance time in the activation process of the present disclosure, the following process was performed.

In this case, the activation maintenance time was changed into 0, 30, 60, and 90 minutes, respectively while the activation temperature was fixed at 450° C. Thereafter, properties of the CNTs in the metal composite-based anode active material prepared and cycle life characteristics of a secondary battery including the anode active material were each measured, and are shown in the following Table 2 and FIG. 5.

TABLE 2

| | Content of | Activation | | CNT | |
|---|---|---|---|---|---|
| | metal | maintenance | Activation | synthesis | Cycle life |
| | impurities | temperature | maintenance | temperature | characteristics |
| | [ppm] | [° C.] | time [Min] | [° C.] | (@50^{th}) [%] |
| Comparative | <50 | 450 | 60 | 600 | 78.0 |
| Example 1 | | | | | |
| Comparative | >150 | 450 | 0 | 600 | 74.3 |
| Example 2 | | | | | |
| Comparative | >150 | 450 | 30 | 600 | 77.4 |
| Example 3 | | | | | |
| Comparative | >150 | 450 | 90 | 600 | 78.3 |
| Example 4 | | | | | |
| Example 1 | >150 | 450 | 60 | 600 | 81.0 |

As a result of the experiment, in the case of Comparative Example 1 in which the content of metal impurities was 50 ppm or less, carbon nanotubes (CNTs) were not synthesized on the surface of the active material even though the activation maintenance time was maintained at 60 minutes and a hydrocarbon gas was supplied. Further, it was confirmed that a battery including the metal composite-based anode active material had a cycle life characteristic of 78.0%.

In the case of Comparative Examples 2 and 3 in which the activation maintenance time was maintained at 0 and 30 minutes even though the content of metal impurities was 150 ppm or more, carbon nanotubes were not synthesized on the surface even though the hydrocarbon gas was supplied, and cycle life characteristics of a battery were also low (see the following FIG. 1). It is judged that metal impurities affect decomposition of the electrolytic solution and formation of surface side reactants, and the like during the charge and discharge process of the battery, thereby rather exerting adverse effects on cycle life characteristics of the battery.

Even when the activation maintenance time was prolonged to 90 minutes or more as described in Comparative Example 4, carbon nanotubes were not synthesized on the surface of the active material. It is assumed that the metal impurity to be used as the catalyst was continuously heated from the outside, and was evaporated and removed even after the surface activation.

Meanwhile, in the case of Example 1 in which the activation maintenance timewas maintained at 60 minutes and the hydrocarbon gas was supplied, it could be confirmed that carbon nanotubes were synthesized on the surface (see the following FIG. 2). Further, it could be confirmed that a secondary battery including the metal composite-based anode active material had been improved cycle life characteristics by 81.0% (see the following FIG. 5).

### EXPERIMENTAL EXAMPLE 3

### Evaluation of Growth of CNTs Depending on Activation Maintenance Temperature and Characteristics of Battery

In order to confirm a change in growth of carbon nanotubes (CNTs) depending on the maintenance temperature in the activation process of the present disclosure, the following process was performed.

In this case, the activation maintenance temperature was changed into 450° C., 500° C., and 550° C., respectively, while the activation maintenancetime was fixed at 60 minutes. Thereafter, properties of the CNTs in the metal composite-based anode active material prepared and cycle life characteristics of a secondary battery including the anode active material were each measured, and are shown in the following Table 3 and FIG. 6.

TABLE 3

| | Content of | Activation | | CNT | | Cycle life |
|---|---|---|---|---|---|---|
| | metal | maintenance | Activation | synthesis | Raman | characteristics |
| | impurities | temperature | maintenance | temperature | I₁₃₅₀/I₁₅₈₀ | (@50^{th}) |
| | [ppm] | [° C.] | time [Min] | [° C.] | of CNTs | [%] |
| Example 1 | >150 | 450 | 60 | 600 | 1.10 | 81.0 |
| Example 2 | >150 | 500 | 60 | 600 | 0.91 | 83.9 |
| Example 3 | >150 | 550 | 60 | 600 | 0.72 | 88.0 |

As a result of the experiment, it could be seen that as the activation maintenance temperature was increased, metal impurities in the spherical carbon particle were highly activated, and thus, more carbon nanotubes (CNTs) were synthesized on the surface, and it could be confirmed that cycle life characteristics of the battery were further improved because more carbon nanotubes were synthesized (see the following FIG. 6).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An anode active material, comprising:
a composite particle comprising silicon and a first carbon; and
carbon nanotubes (CNTs) directly grown on a surface of the composite particle,
wherein the composite particle is a metal catalyst-free type for synthesizing carbon nanotubes.

2. The anode active material of claim 1, wherein the carbon nanotubes have a peak intensity ratio [R=I₁₃₅₀/I₁₅₈₀] in a range of 0.7 to 1.1 in the Raman spectrum (I₁₃₅₀ is a peak intensity of Raman at 1350 cm⁻¹ and I₁₅₈₀ is a peak intensity of Raman at 1580 cm⁻¹).

3. The anode active material of claim 1, wherein the carbon nanotubes are single-walled carbon nanotubes, double-walled carbon nanotubes, or multi-walled carbon nanotubes.

4. The anode active material of claim 1, wherein the first carbon in the composite particle is one or more selected from the group consisting of soft carbon, hard carbon, natural graphite, and artificial graphite.

5. The anode active material of claim 1, wherein the composite particle has a peak intensity ratio [R=I₅₂₀/I₁₅₈₀] in a range of 1.0 to 2.0 in the Raman spectrum (I₅₂₀ derived from Si is a peak intensity of Raman at 520 cm⁻¹ and I₁₅₈₀ derived from carbon is a peak intensity of Raman at 1580 cm⁻¹).

6. The anode active material of claim 1, wherein when a crystallite size of silicon included in the composite particle is measured by an X-ray diffraction method using CuKα rays, a (111) diffraction peak in the Si phase has a full width at half maximum in a range of 0.2° to 1.0°.

7. The anode active material of claim 1, wherein the composite particle comprises an amorphous second carbon coating layer formed on a part or all of the surface of the particle.

8. A lithium secondary battery, comprising:
a cathode;
an anode;
a separator; and
an electrolyte,
wherein the anode comprises the anode active material of claim 1.

9. The lithium secondary battery of claim 8, wherein the carbon nanotubes have a peak intensity ratio [R=I₁₃₅₀/I₁₅₈₀] in a range of 0.7 to 1.1 in the Raman spectrum (I₁₃₅₀ is a peak intensity of Raman at 1350 cm⁻¹ and I₁₅₈₀ is a peak intensity of Raman at 1580 cm⁻¹).

10. The lithium secondary battery of claim 8, wherein the carbon nanotubes are single-walled carbon nanotubes, double-walled carbon nanotubes, or multi-walled carbon nanotubes.

11. The lithium secondary battery of claim 8, wherein the first carbon in the composite particle is one or more selected from the group consisting of soft carbon, hard carbon, natural graphite, and artificial graphite.

12. The lithium secondary battery of claim 8, wherein the composite particle has a peak intensity ratio [R=I₅₂₀/I₁₅₈₀] in a range of 1.0 to 2.0 in the Raman spectrum (I₅₂₀ is a peak intensity of Raman at 520 cm⁻¹ and I₁₅₈₀ is a peak intensity of Raman at 1580 cm⁻¹).

13. The lithium secondary battery of claim 8, wherein when a crystallite size of silicon included in the composite particle is measured by an X-ray diffraction method using CuKα rays, a (111) diffraction peak in the Si phase has a full width at half maximum in a range of 0.2° to 1.0°.

14. The lithium secondary battery of claim 8, wherein the composite particle comprises an amorphous second carbon coating layer formed on a part or all of the surface of the particle.

15. A method of preparing an anode active material, the method comprising:
(i) preparing a composite particle comprising silicon and a first carbon, in which the first carbon contains 150 ppm to 5,000 ppm of metal impurities;
(ii) activating the composite particle by maintaining the composite particle at 400° C. to 900° C. for more than 30 minutes and less than 90 minutes; and
(iii) vapor-phase growing carbon nanotubes on a surface of the activated composite particle by performing a heat treatment at a temperature which is equal to or more than a decomposition temperature of a hydrocarbon gas while supplying a hydrocarbon gas under metal catalyst-free conditions.

16. The method of claim 15, wherein the metal impurity is an inevitable metal or metal oxide present in the first carbon, and comprises at least one element selected from the group consists of Fe, Cu, Pb, Co, Ni, Pt, Pd, Mn, Mo, Cr, Sn, Au, Mg, Al, Ca, K, Na, P, Zn, and Nb.

17. The method of claim 16, wherein a content of metal impurities comprising Fe and Ni is in a range of 150 ppm to 3,000 ppm.

18. The method of claim 15, wherein the composite particle in step (i) is formed by compositing silicon fine particles with a spheroidized first carbon particle by a dry method or a wet method.

19. The method of claim 15, wherein step (i) further comprises step (i-1) of coating a surface of the composite particle with a carbonizable precursor, and then performing a heat treatment at a temperature which is equal to or more than a temperature at which the precursor is carbonized.

20. The method of claim 15, wherein in step (iii), carbon nanotubes are directly grown on the surface of the composite particle by performing a chemical vapor deposition at 500° C. to 1,300° C. under a mixed gas atmosphere of a hydrocarbon gas represented by CxHy (x: 1 to 3, y: 2 to 11) and an inert gas, and thermally decomposing and carbonizing the hydrocarbon gas.
